(19) United States
(12) Patent Application Publication
(10) Pub. No.: US 2025/0288978 A1
(43) Pub. Date: Sep. 18, 2025

(54) MULTI-ELEMENT CATALYST INCLUDING INTERMETALLIC ALLOY NANOPARTICLES AND METHOD FOR PREPARING THE SAME

(71) Applicant: KOREA INSTITUTE OF SCIENCE AND TECHNOLOGY, Seoul (KR)

(72) Inventors: Sung Jong YOO, Seoul (KR); Yongju HONG, Seoul (KR); Jae-hyun PARK, Seoul (KR); Katie Heeyum LIM, Seoul (KR); Bora SEO, Seoul (KR); Hee-Young PARK, Seoul (KR); So Young LEE, Seoul (KR); Sung Ki CHO, Seoul (KR); Hyun Seo PARK, Seoul (KR); Jin Young KIM, Seoul (KR); Jong Hyun JANG, Seoul (KR)

(73) Assignee: KOREA INSTITUTE OF SCIENCE AND TECHNOLOGY, Seoul (KR)

(21) Appl. No.: 19/076,471

(22) Filed: Mar. 11, 2025

(30) Foreign Application Priority Data
Mar. 12, 2024 (KR) 10-2024-0034299

(51) Int. Cl. B01J 23/89; B01J 21/18; B01J 35/45; H01M 4/90

(52) U.S. Cl. CPC B01J 23/8913; B01J 21/18; B01J 35/45; H01M 4/9041; B01J 2235/15; B01J 2235/30

(57) ABSTRACT

The present disclosure relates to a multi-element catalyst and a method for preparing the same. The multi-element catalyst of the present disclosure, wherein a noble metal and a transition metal form an intermetallic crystal structure and are supported on a carbon support with strong binding force, can exhibit excellent durability, stability, and catalytic activity.

### CROSS-REFERENCE TO RELATED APPLICATION

This application claims priority of Korean Patent Application No. 10-2024-0034299 filed on Mar. 12, 2024, in the Korean Patent Office, and all the benefits accruing therefrom under 35 U.S.C. § 119, the entire contents of which are herein incorporated by reference for all purposes.

### BACKGROUND

### 1. Field

The present disclosure relates to a multi-element catalyst containing intermetallic alloy nanoparticles and a method for preparing the same.

### 2. Description of the Related Art

Fuel cells are next-generation energy source generation devices that convert chemical energy into electrical energy. They are receiving a lot of attention because they do not emit any environmental pollutants. In particular, polymer electrolyte membrane fuel cells (or proton-exchange membrane fuel cells, PEMFCs) that can operate at low temperatures have been applied to electric vehicles, leading to the successful production of eco-friendly vehicles that do not emit pollutants, and they have already reached the stage of commercialization.

The catalyst mainly used in fuel cells is platinum. Researches are actively being conducted on alloying it with other metal particles to reduce the amount of the expensive platinum used and increase the activity of the catalyst. However, there is a disadvantage in that high activity cannot be maintained during long-term operation because the second and third metals alloyed with platinum are easily dissolved out under fuel cell operating conditions.

Accordingly, researches have been conducted on a technology for making the atomic arrangement of alloy nanoparticles uniform through heat treatment at high temperatures in order to achieve high activity and stability at the same time. Although the phenomenon of metal dissolution out of the alloy nanoparticles was improved to some extent, the degree was insignificant, and there was a problem that the aggregation of the metal particles during the high-temperature heat treatment reduces the surface area.

Meanwhile, a catalyst is mainly composed of catalytic metal particles and a support with high electrical conductivity for uniformly dispersing them. The electrochemical reaction activity of the noble metal-supported catalyst depends on the number and density of active reaction sites of the catalyst. Therefore, uniform distribution of the catalyst on the electrode is essential to increase electrochemical reaction activity and improve durability. However, the existing nanoparticle synthesis methods have the problem that it is very difficult to control the formation of catalyst particles and the dispersibility of the particles formed on the support simultaneously. In particular, highly crystalline carbon, which has excellent conductivity and stability among carbon supports, is a promising support that surpasses existing commercial carbon supports for high-performance catalysts. But, there is a limitation in that the method for supporting a catalyst is very limited due to its high crystallinity.

Accordingly, there is a need for technology development for a catalyst containing alloy nanoparticles that can not only improve the phenomenon of metal dissolution through regular control of the atomic arrangement of nanoparticles, but can also be stably supported regardless of the crystallinity of the carbon support.

### REFERENCES OF RELATED ART

### Patent Documents

(Patent Document 1) Patent Document 1. Korean Patent Registration No. 10-2023-0073126

### SUMMARY

The present disclosure is directed to providing a multi-element catalyst containing: a carbon support; and nanoparticles supported on the carbon support and including a noble metal and a first transition metal, wherein the nanoparticles have a core-shell structure in which a core of an intermetallic alloy phase including the first transition metal and the noble metal is surrounded by a shell including the noble metal.

In addition, the present disclosure is directed to providing an electrode for a fuel cell, which includes the multi-element catalyst.

In addition, the present disclosure is directed to providing a fuel cell including the electrode for a fuel cell.

The present disclosure provides a method for preparing a multi-element catalyst, which includes: (i) a step of reacting a mixture of a carbon support, a noble metal precursor, a first transition metal precursor, a surface stabilizer, and a reducing agent in a solvent; (ii) a step of performing first heat treatment on the reacted mixture; (iii) a step of immersing the first heat-treated mixture in an acid solution; and (iv) a step of a step of performing second heat treatment on the mixture immersed in the acid solution, wherein the multi-element catalyst includes nanoparticles having a core-shell structure in which a core of an intermetallic alloy phase including the first transition metal and the noble metal is surrounded by a shell including the noble metal.

The present disclosure provides a multi-element catalyst containing: a carbon support; and nanoparticles supported on the carbon support and including a noble metal and a first transition metal, wherein the nanoparticles have a core-shell structure in which a core of an intermetallic alloy phase including the first transition metal and the noble metal is surrounded by a shell including the noble metal.

In addition, the present disclosure provides an electrode for a fuel cell, which includes the multi-element catalyst.

In addition, the present disclosure provides a fuel cell including the electrode for a fuel cell.

In addition, the present disclosure provides a method for preparing a multi-element catalyst, which includes: (i) a step of reacting a mixture of a carbon support, a noble metal precursor, a first transition metal precursor, a surface stabilizer, and a reducing agent in a solvent; (ii) a step of performing first heat treatment on the reacted mixture; (iii) a step of immersing the first heat-treated mixture in an acid solution; and (iv) a step of a step of performing second heat treatment on the mixture immersed in the acid solution, wherein the multi-element catalyst includes nanoparticles having a core-shell structure in which a core of an intermetallic alloy phase including the first transition metal and the noble metal is surrounded by a shell including the noble metal.

The multi-element catalyst of the present disclosure can improve the phenomenon of metal dissolution since the noble metal and the first transition metal form an intermetallic crystal structure and the arrangement of atoms is controlled regularly.

In addition, according to the method for preparing a multi-element catalyst of the present disclosure, wherein alloy nanoparticles are formed from the reaction of the noble metal precursor, the transition metal precursor, and the reducing agent, and the surface is controlled by acid treatment, so that core-shell structured nanoparticles in which platinum forms a shell surrounding the surface of the alloy nanoparticles are supported on a carbon support, and heat-treated to form an intermetallic crystal structure, the aggregation phenomenon of the nanoparticles can be improved and the nanoparticles are allowed to have strong bonding strength regardless of the crystallinity of the carbon support. As a result, the activity, durability, mechanical properties and stability of the catalyst can be improved significantly.

In addition, since the method for preparing a multi-element catalyst of the present disclosure allows the preparation of a multi-element catalyst in a simple manner by direct growth by minimizing the amount of chemicals used and omitting the step of pretreatment of highly crystalline carbon, it is easily applicable to large-scale production and is advantageous in that a nanocatalyst with high dispersion stability can be prepared.

The effect of the present disclosure is not limited to that mentioned above. It should be understood that the effects of the present disclosure include all the effects that can be inferred from the following description.

### BRIEF DESCRIPTION OF THE DRAWINGS

FIG. 1 schematically describes a method for preparing a multi-element catalyst of the present disclosure.

FIGS. 2A and 2B show (2A) a transmission electron microscope (TEM) image, and (2B) an energy-dispersive X-ray spectroscopy (EDS) elemental mapping image of a multi-element catalyst prepared in Example 1 of the present disclosure.

FIGS. 3A-3C show (3A) a high-resolution transmission electron microscope (HRTEM) image, (3B) a line profile, and (3C) an X-ray diffraction (XRD) analysis result for highly crystalline carbon used in a multi-element catalyst prepared in Example 1 of the present disclosure.

FIGS. 4A and 4B show the high-resolution scanning transmission electron microscope (HRSTEM) image, and the FFT (fast Fourier transfer) analysis and line profile analysis results of the multi-element catalyst prepared in Example 1 of the present disclosure.

FIGS. 5A and 5B show the transmission electron microscopy (TEM) image and energy-dispersive X-ray spectroscopy (EDS) elemental mapping image of the multi-element catalyst prepared in Example 2.

FIG. 6 shows the transmission electron microscope (TEM) image of the catalyst prepared in Comparative Example 1 of the present disclosure.

FIGS. 7A and 7B show X-ray diffraction analysis (XRD) result for the multi-element catalysts prepared in Example 1 (Pt_{0.66}Co_{0.21}Fe_{0.13}/HCC) and Example 2 (Pt₃Fe/HCC) of the present disclosure.

### DETAILED DESCRIPTION

The advantages and features of the present disclosure and the methods for achieving them will become apparent with reference to the exemplary embodiments described in detail below together with the accompanying drawings. However, the present disclosure is not limited to the embodiments disclosed below, but may be implemented in various different forms, and these embodiments are provided only to make the disclosure of the present disclosure complete and to fully inform a person having ordinary skill in the art to which the present disclosure pertains of the scope of the invention, and the present disclosure is defined only by the scope of the claims.

In describing the present disclosure, if it is determined that a detailed description of a related known technology may unnecessarily obscure the gist of the present disclosure, the detailed description will be omitted. When the words “include”, “have”, and “consist of”, etc. are used in this specification, other components may also be added, unless “only” is used. Furthermore, terms such as “include”, “have”, etc. should not be construed as excluding the presence or addition of one or more other features, numbers, steps, components, or combinations thereof, but rather as specifying the presence of the features, numbers, steps, components, or combinations thereof described in the specification. Additionally, when a component is expressed in singular form, it includes the presence of plural components unless there is a special explicit description.

Hereinafter, the present disclosure will be described in more detail.

As described above, conventional alloy nanoparticles suffer from metal loss and particle aggregation at high temperatures, and are not supported uniformly on a carbon support with sufficient binding strength. Accordingly, in the present disclosure, by controlling the surface of alloy nanoparticles of a transition metal and a noble metal, such that a core-shell structure is formed in which a shell including a noble metal surrounds the core of the alloy nanoparticles, and converting the alloy nanoparticles of the core-shell structure supported on the carbon support into an intermetallic phase crystal structure, the phenomenon of loss and aggregation is improved by allowing the alloy nanoparticles to be supported on the carbon support with a strong bonding force.

More specifically, an aspect of the present disclosure provides a multi-element catalyst containing: a carbon support; and nanoparticles supported on the carbon support and including a noble metal and a first transition metal, wherein the nanoparticles have a core-shell structure in which a core of an intermetallic alloy phase including the first transition metal and the noble metal is surrounded by a shell including the noble metal.

Since the nanoparticles of the multi-element catalyst exhibit an intermetallic crystal structure, the phenomenon of loss and dissolution of components is improved significantly and the morphological stability can be enhanced even after long-term use of the catalyst. If, unlike the present disclosure, an intermetallic crystal structure is not formed, the phenomenon of loss and dissolution of components may be observed or the shape may change compared to the initial state when the catalyst is used for a long period of time or left in the air for a long period of time.

The alloy nanoparticles exhibiting an intermetallic crystal structure included in the multi-element catalyst can be confirmed by X-ray diffraction (PXRD) or transmission electron microscopy (TEM).

The intermetallic crystal structure of the multi-element catalyst can be confirmed from the regular atomic arrangement and L₁₂ superlattice structure in the transmission electron microscope (TEM) image.

As a result of X-ray diffraction (PXRD) analysis, the multi-element catalyst exhibits a first main peak and a second main peak at 2θ of 40° to 45° and 45° to 50°, respectively, and exhibits a first effective peak, a second effective peak, a third effective peak, and a fourth effective peak at 2θ of 20° to 25°, 30° to 35°, 50° to 55°, and 55° to 60°, respectively, and an intensity ratio of the second effective peak to the first main peak ((second effective peak)/(first main peak)) of 0.0156 to 0.078, specifically 0.02 to 0.078, more specifically 0.025 to 0.078, and most specifically 0.03 to 0.078, indicating that the catalyst exhibits an intermetallic crystal structure.

Theoretically, when the nanoparticles exhibit a complete intermetallic crystal structure, the intensity ratio of the second effective peak to the first main peak ((second effective peak)/(first main peak)) becomes 0.078. Therefore, it can be seen that a complete intermetallic phase is exhibited as the (second effective peak)/(first main peak) ratio is closer to 0.078.

If the multi-element catalyst does not exhibit any one of the first to fourth effective peaks, or if the intensity ratio of the second effective peak to the first main peak ((second effective peak)/(first main peak)) is lower than 0.0156, the phenomenon of loss and dissolution of components may be observed, or the shape may change somewhat as compared to the initial state when the catalyst used for a long time, since an intermetallic crystal structure is not formed.

In the present disclosure, the term ‘main’ or ‘effective (or significant)’ peak means a peak that is detected repeatedly with a pattern that can be regarded in the art as being substantially identical, without being significantly affected by analysis conditions or analysts in analysis data such as Raman, XRD, etc. It is obvious that a person of ordinary skill in the art to which the present disclosure belongs can easily determine whether a particular peak is an effective peak.

The multi-element catalyst of the present disclosure exhibits a core-shell structure in which a core including the first transition metal and the noble metal is surrounded by a shell including the noble metal. As a result, catalytic performance can be improved since the stability of the core and the intrinsic activity and stability of the noble metal shell are improved.

Some of the noble metal may form the core, and others may form the shell.

The carbon support may include one or more selected from a group consisting of carbon black, carbon nanotube (CNT), carbon nanofiber (CNF), graphene nanosheet (GNS), Ketjen black, graphene, graphene oxide, and carbon nanosphere.

In a nanocatalyst in which nanoparticles are supported on a carbon support, electrical conductivity and chemical resistance increase as the crystallinity of the carbon support increases and, as a result, the catalytic activity and stability of the nanocatalyst supported thereon are improved. Therefore, efforts have been made to support nanoparticles on a highly crystalline carbon support. However, in the past, there was a problem that it was difficult to support the catalyst itself on the highly crystalline carbon support due to the absence of binding sites and the absence of a methodology for binding the catalyst, or that it was difficult to prepare a catalyst exhibiting an intermetallic alloy structure using the highly crystalline carbon support because aggregation occurs very easily during the heat treatment process even after the supporting. However, according to the present disclosure, the nanoparticles are surface-controlled to form a core-shell structure, and the nanoparticles with the core-shell structure are supported on a carbon support and converted into an intermetallic crystal structure, so that they are supported with excellent binding force even when the carbon support with high crystallinity is used.

The carbon support may be a highly crystalline carbon support, and the crystallinity of the carbon support may be measured by X-ray diffraction (PXRD) or transmission electron microscopy (TEM).

More specifically, when the carbon support is a highly crystalline carbon support, the distance between (002) crystal planes may be 2 to 5 nm, specifically 2.5 to 4.5 nm, more specifically 3 to 4 nm, and more specifically 3.3 to 3.5 nm, as determined by transmission electron microscopy (TEM) analysis. If the distance between crystal planes is smaller than the lower limit as a result of transmission electron microscope (TEM) analysis, electrical conductivity and chemical resistance may decrease due to low crystallinity. Conversely, if it exceeds the upper limit, aggregation of nanoparticles may be observed.

And, when the carbon support is a highly crystalline carbon support, the half-width of the first peak appearing at 20° to 30° may be smaller than 3° as a result of X-ray diffraction (XRD) analysis. If the half-width of the first peak of the carbon support is 3° or larger, the electrical conductivity and chemical resistance are relatively low and the catalytic activity and stability of the nanocatalyst supported thereon may be reduced because of low crystallinity of the carbon support. The carbon support may be a highly crystalline carbon support in that the upper limit of the half-width of the first peak is 3°.

The noble metal may be one or more selected from a group consisting of platinum (Pt), gold (Au), silver (Ag), palladium (Pd), iridium (Ir), osmium (Os), rhodium (Rh), and ruthenium (Ru), specifically one or more selected from a group consisting of platinum (Pt), palladium (Pd), and rhodium (Rh). Most specifically, it may be platinum (Pt).

The noble metal may be included in an amount of 63 to 80 atomic %, specifically 64 to 72 atomic %, more specifically 65 to 68 atomic %, and most specifically 65.8 to 67 atomic %, per 100 atomic % of the total nanoparticles. If the noble metal is included in an amount less than the lower limit, the stability and catalytic activity of the core-shell structure may deteriorate. And conversely, if it is included in an amount exceeding the upper limit, aggregation and nonuniform dispersion of the nanoparticles may be observed.

The nanoparticles may further include a second transition metal that is different from the first transition metal, and when the nanoparticles further include the second transition metal, it is advantageous in that the amount of platinum used is reduced and the catalytic activity is increased due to alloy and core-shell effects. The core further includes the second transition metal.

In addition, the nanoparticles may further include a plurality of transition metals that are different from the first transition metal and the second transition metal, so that the nanoparticles may include the first transition metal, the second transition metal, . . . , and an n-th transition metal. In this case, it is advantageous in that the surface energy of platinum (Pt) resulting from various alloy combinations and compositions can be controlled precisely and, thus, the activity and stability of the catalyst can be improved.

The first transition metal, the second transition metal, . . . , and the n-th transition metal are different from each other and may include one or more selected from a group consisting of iron (Fe), cobalt (Co), chromium (Cr), manganese (Mn), nickel (Ni), and vanadium (V).

When the nanoparticles include a noble metal and a first transition metal, the nanoparticles may be represented by Chemical Formula 1.

AₓB_{y} [Chemical Formula 1]

In Chemical Formula 1, 0.63≤x≤0.8, 0.2≤y≤0.37 and x+y=1, A is one or more noble metal selected from a group consisting of platinum (Pt), gold (Au), silver (Ag), palladium (Pd), iridium (Ir), osmium (Os), rhodium (Rh), and ruthenium (Ru), and B is one or more transition metal selected from a group consisting of iron (Fe), cobalt (Co), chromium (Cr), manganese (Mn), nickel (Ni), and vanadium (V).

When the nanoparticles include a noble metal, a first transition metal, and a second transition metal, the nanoparticles may be represented by Chemical Formula 2.

AₓB_{y}C_{z} [Chemical Formula 2]

In Chemical Formula 2, 0.63≤x≤0.72, 0.15≤y≤0.28, 0.8≤z≤0.2, and x+y+z=1, A is one or more noble metal selected from a group consisting of platinum (Pt), gold (Au), silver (Ag), palladium (Pd), iridium (Ir), osmium (Os), rhodium (Rh), and ruthenium (Ru), and B and C, which are different from each other, are one or more transition metals selected from a group consisting of iron (Fe), cobalt (Co), chromium (Cr), manganese (Mn), nickel (Ni), and vanadium (V).

When the first transition metal and the second transition metal are iron (Fe) and cobalt (Co), respectively, it is preferred in that they are bound stronger even when the carbon support exhibits high crystallinity.

Specifically, the noble metal may be platinum (Pt), the first transition metal may be cobalt (Co), and the second transition metal may be iron (Fe). More specifically, the nanoparticles may be represented by Chemical Formula 3.

PtₓCo_{y}Fe_{z} [Chemical Formula 3]

In Chemical Formula 3, 0.63≤x≤0.72, 0.15≤y≤0.28, 0.08≤z≤0.2, and x+y+Z=1.

When the first transition metal and the second transition metal are iron (Fe) and cobalt (Co), respectively, the iron (Fe) may be included in an amount of 8 to 20 atomic %, specifically 10 to 18 atomic %, and more specifically 11 to 15 atomic %, and the cobalt (Co) may be included in an amount of 15 to 28 atomic %, specifically 17 to 25 atomic %, more specifically 18 to 23 atomic %, and most specifically 20 to 22 atomic %, per 100 atomic % of the total nanoparticles.

When the amount of either of the iron (Fe) and the cobalt (Co) is outside the atomic % ranges described above, the stability of the core-shell structure deteriorates.

The size of the nanoparticles may be 1 to 15 nm, specifically 3 to 12 nm, more specifically 5 to 10 nm, and most specifically 6 to 7 nm. If the size of the nanoparticle is smaller than the lower limit, stability may be reduced. And conversely, if it exceeds the upper limit, catalytic activity may decrease.

According to a specific exemplary embodiment of the present disclosure, (1) the carbon support may have the distance between (002) crystal planes 3.3 to 3.5 nm as determined by transmission electron microscopy (TEM) analysis, and a half-width of the first peak appearing at 20° to 30° of smaller than 3° as determined by X-ray diffraction (XRD) analysis, (2) the multi-element catalyst may exhibit a first main peak and a second main peak at 2θ of 40° to 45° and 45° to 50°, respectively, and exhibit a first effective peak, a second effective peak, a third effective peak, and a fourth effective peak at 2θ of 20° to 25°, 30° to 35°, 50° to 55°, and 55° to 60°, respectively, and an intensity ratio of the second effective peak to the first main peak ((second effective peak)/(first main peak)) of 0.03 to 0.078, (3) the noble metal may be platinum (Pt), the first transition metal may be iron (Fe), and the nanoparticles may further include cobalt (Co), (4) the amount of the noble metal may be 65.8 to 67 atomic %, the amount of the iron (Fe) may be 11 to 15 atomic %, and the amount of the cobalt (Co) may be 20 to 22 atomic %, per 100 atomic % of the total nanoparticles, and (5) the size of the nanoparticles may be 6 to 7 nm. It was confirmed that, when the multi-element catalyst of the present disclosure satisfies all of the conditions (1) to (5), thermal stability is improved, and that even when the electrode for a fuel cell using the catalyst is operated at a high temperature for a long period of time, the performance and surface roughness are maintained at a level similar to the initial levels.

The multi-element catalyst may exhibit catalytic activity for oxygen reduction reaction, hydrogen evolution reaction, ammonia oxidation reaction, hydrogen oxidation reaction, water electrolysis-based catalytic reaction, and fuel cell-based catalytic reaction.

Another aspect of the present disclosure provides an electrode for a fuel cell, which includes the multi-element catalyst.

Another aspect of the present disclosure provides a fuel cell including the electrode for a fuel cell.

The present disclosure provides a device including the fuel cell, wherein the device is a transport device or an energy storage device.

Meanwhile, the present disclosure also provides a method for preparing a multi-element catalyst, which includes: (i) a step of reacting a mixture of a carbon support, a noble metal precursor, a first transition metal precursor, a surface stabilizer, and a reducing agent in a solvent; (ii) a step of performing first heat treatment on the reacted mixture; (iii) a step of immersing the first heat-treated mixture in an acid solution; and (iv) a step of a step of performing second heat treatment on the mixture immersed in the acid solution, wherein the multi-element catalyst includes nanoparticles having a core-shell structure in which a core of an intermetallic alloy phase including the first transition metal and the noble metal is surrounded by a shell including the noble metal.

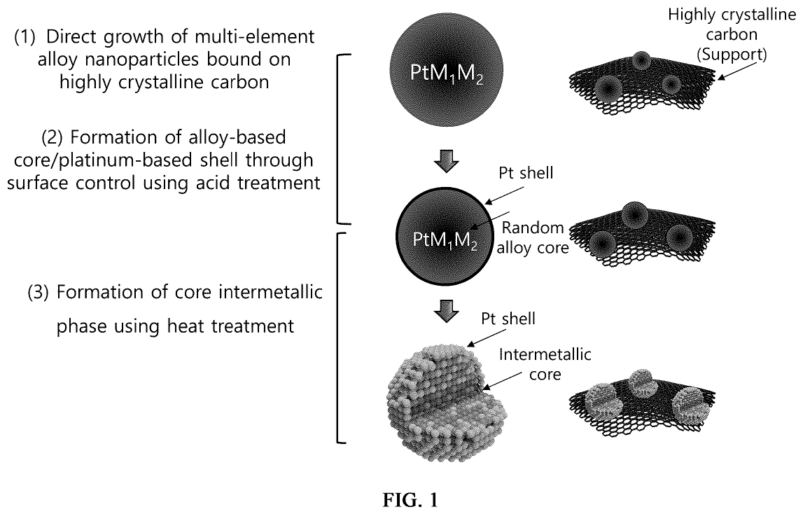

FIG. 1 schematically describes a method for preparing a multi-element catalyst of the present disclosure.

Referring to the FIG. 1, it can be seen that alloy nanoparticles of a transition metal and a noble metal grow as the noble metal precursor, the first transition metal precursor, the surface stabilizer, and the reducing agent react on the carbon support. When the alloy nanoparticles are acid-treated, the surface is controlled so that the noble metal forming the alloy moves to the surface of the alloy nanoparticles and surrounds the alloy nanoparticles, thereby forming a core-shell structure in which a core including the first transition metal and the noble metal is surrounded by a shell including the noble metal. Next, it can be seen that an intermetallic phase is formed when the alloy nanoparticles of the core-shell structure are heat-treated.

Hereinafter, each step of the method for preparing a multi-element catalyst of the present disclosure will be described in more detail.

### (i) a Step of Reacting a Mixture of a Carbon Support, a Noble Metal Precursor, a Transition Metal Precursor, a Surface Stabilizer, and a Reducing Agent in a Solvent

The solvent may be one or more selected from a group consisting of DMF (N N-dimethylformamide), N-methyl-2-pyrrolidone (NMP), dimethylacetamide (DMAc), dimethyl sulfoxide (DMSO), ethyl acetate, dichloromethane, ether, chloroform, and acetone.

The carbon support may be one or more selected from a group consisting of carbon black, carbon nanotube (CNT), carbon nanofiber (CNF), graphene nanosheet (GNS), Ketjen black, graphene, graphene oxide, and carbon nanosphere.

The carbon support may be a highly crystalline carbon support having an interplanar distance of 2 to 5 nm, specifically 2.5 to 4.5 nm, more specifically 3 to 4 nm, and more specifically 3.3 to 3.5 nm, as determined by transmission electron microscopy (TEM) analysis, or exhibiting a half-width of a first peak appearing at 20° to 30° of smaller than 5° as determined by X-ray diffraction (XRD) analysis.

The noble metal precursor may be one or more precursor selected from a group consisting of platinum (Pt), gold (Au), silver (Ag), palladium (Pd), iridium (Ir), osmium (Os), rhodium (Rh), and ruthenium (Ru), specifically one or more precursor selected from a group consisting of platinum (Pt), palladium (Pd), and rhodium (Rh). Most specifically, it may be a platinum (Pt) precursor.

The platinum (Pt) precursor may be one or more selected from a group consisting of platinum acetylacetonate (Pt(acac)₂), platinum fluoride, and platinum hexaacetylacetonate. Specifically, platinum acetylacetonate (Pt(acac)₂) may be used.

The first transition metal precursor may be a precursor of one or more first transition metal selected from a group consisting of iron (Fe), cobalt (Co), chromium (Cr), manganese (Mn), nickel (Ni), and vanadium (V).

The mixture may further include a precursor of a second transition metal which is different from the first transition metal.

The mixture may further include a plurality of precursors of transition metals that are different from the first transition metal and the second transition metal. For example, the mixture may include a first transition metal precursor, a second transition metal precursor, . . . , and an n-th transition metal precursor.

Each of the first transition metal precursor, the second transition metal precursor, . . . , and the n-th transition metal precursor may include one or more different transition metal selected from a group consisting of iron (Fe), cobalt (Co), chromium (Cr), manganese (Mn), nickel (Ni), and vanadium (V), and it may be one or more selected from a group consisting of a carbonylate, a chloride, a hydroxide, carbonate, a sulfur oxide, and a sulfide of the transition metal.

Most specifically, the first transition metal may be an iron (Fe) precursor, and the second transition metal may be a cobalt (Co) precursor. More specifically, the first transition metal precursor may be Fe(CO)₅, and the second transition metal precursor may be Co₂(CO)₈.

The surface stabilizer may be one or more selected from a group consisting of benzoic acid, oleylamine, and trioctylphosphine. Specifically, it may be benzoic acid. If a surface stabilizer is not used, even if the nanoparticles and the metal exhibit uniform distribution and size in the early stage of synthesis, the shape and size may become nonuniform after long-term use.

The reducing agent may be one or more selected from a group consisting of ethylene glycol (EG), 1,2-hexadecanediol, and 1,5-pentanediol.

The concentration of the carbon support in the solvent may be 0.1 to 15 g/L, specifically 0.5 to 10 g/L, more specifically 1 to 7 g/L, and most specifically 2 to 5 g/L. If the concentration of the carbon support in the solvent is lower than the lower limit, the nanoparticles of the finally prepared multi-element catalyst may aggregate with each other, which may reduce the active sites of the catalyst. Conversely, if it exceeds the upper limit, the catalytic activity of the finally prepared multi-element catalyst may be reduced.

The weight ratio of the carbon support and the sum of the transition metal precursor and the noble metal precursor (carbon support: (transition metal precursor+noble metal precursor)) may be 30:55 to 160, specifically 30:80 to 150, more specifically 30:90 to 140, most specifically 30:100 to 130.

If the weight ratio is lower than 30:55, the alloy nanoparticles may not grow enough since the amount of the carbon support is relatively large. And conversely, if it exceeds 30:160, the nanoparticles may be dispersed nonuniformly on the carbon support with irregular sizes since the amount of carbon support is relatively small.

In particular, the reaction of the step (i) may be performed by solvothermal synthesis. If the nanoparticles are synthesized by a method different from that of the present disclosure, they cannot be supported on a carbon support with high crystallinity, and it may be very difficult to prepare ternary or higher nanoparticles.

The reaction of the step (i) may be carried out at 100 to 150° C. for 1 to 30 minutes, specifically at 110 to 130° C. for 5 to 25 minutes, more specifically at 115 to 125° C. for 8 to 20 minutes. If any of the reaction temperature and time of the step (i) is outside the above ranges, the nanoparticles may not be distributed uniformly but may be aggregated because the precursor is not dissociated and mixed sufficiently. In particular, when both the temperature and time ranges of the reaction of the step (i) are satisfied, it is advantageous in that the synthesis of ternary or higher nanoparticles can be achieved on the carbon support with very high crystallinity with high yield and purity, regardless of the type and combination of the constituent metals.

### (ii) A Step of Performing First Heat Treatment on the Reacted Mixture

Next, the reacted mixture is subjected to first heat treatment so that nanoparticles are bound and grow on the carbon support.

The first heat treatment may be performed at 120 to 200° C. for 0.3 to 3 hours, specifically at 130 to 180° C. for 0.5 to 2 hours, more specifically at 150 to 170° C. for 0.6 to 1.5 hours, and most specifically at 155 to 165° C. for 0.8 to 1.2 hours. If either of the temperature and time of the first heat treatment is below the lower limit, alloy nanoparticles may not grow because of insufficient reduction of the transition metal precursor and the noble metal precursor. Conversely, if it exceeds the upper limit, the nanoparticles may aggregate with each other.

(iii) A Step of Immersing the First Heat-Treated Mixture in an Acid Solution

In the step (iii), the first heat-treated mixture is immersed in an acid solution.

Before the first heat-treated mixture is immersed in the acid solution, the first heat-treated mixture may be centrifuged to extract the carbon-supported alloy catalyst, and then it may be immersed in the acid solution.

The acid solution may include one or more selected from a group consisting of nitric acid (HNO₃), hydrochloric acid (HCl), sulfuric acid (H₂SO₄), hydrobromic acid (HBr), hydroiodic acid (HI), perchloric acid (HClO₄), and phosphoric acid (H₃PO₄). Specifically, it may be perchloric acid (HClO₄).

The concentration of the acid solution may be 0.05 to 0.5 M, specifically 0.06 to 0.4 M, more specifically 0.07 to 0.3 M, and most specifically 0.08 to 0.2 M. If the concentration of the acid solution is lower than the lower limit, by-products may remain in the mixture, which may lower the catalytic activity and prevent the shell including the noble metal from being formed enough. Conversely, if the concentration exceeds the upper limit, the carbon support may be corroded.

Since the nanoparticles are prepared by solvothermal synthesis in the method for preparing a multi-element catalyst according to the present disclosure, the step (iii) may be performed at 5 to 30° C., specifically at room temperature. Therefore, the problem of accumulation of by-products that may occur when the acid treatment temperature is high, or deterioration of structural stability does not occur.

The step (iii) may be performed for 0.5 to 1.8 hours, specifically 0.6 to 1.5 hours, more specifically 0.8 to 1.3 hours, and most specifically 0.9 to 1.2 hours. If the reaction time of the step (iii) is outside the above range, a large amount of by-products may be generated.

### (iv) A Step of Obtaining a Multi-Element Catalyst by Performing Second Heat Treatment on the Mixture Immersed in the Acid Solution

The step (iv) is a step of performing second heat treatment on the mixture immersed in the acid solution to convert into an intermetallic crystal structure.

The method for preparing a multi-element catalyst of the present disclosure is characterized in that the second heat treatment is performed after immersing it in an acid solution, so that the intermetallic crystal structure can be maintained even after rapid temperature changes between high and low temperatures several times. On the other hand, when acid treatment is performed after the second heat treatment unlike the present disclosure, it was confirmed that the intermetallic crystal structure may change if rapid temperature changes are repeated.

After the step (iv), nanoparticles having a core-shell structure in which a core of the intermetallic alloy phase including the first transition metal and the noble metal is surrounded by a shell including the noble metal is formed, and the nanoparticles are supported on the carbon support with high binding force.

The second heat treatment may be performed in an inert gas atmosphere at 600 to 900° C. for 0.5 to 6 hours, specifically at 620 to 850° C. for 1 to 5 hours, more specifically at 650 to 800° C. for 1.5 to 4.5 hours, and most specifically at 680 to 730° C. for 2 to 4 hours. If one or more of the temperature and time of the second heat treatment is below the lower limit, the finally prepared multi-element catalyst may not be converted into an intermetallic crystal structure. And conversely, if it exceeds the upper limit, the active sites may be reduced and the catalytic properties may be deteriorated due to aggregation of the finally prepared multi-element catalyst.

The inert gas may mean a gas including one or more selected from a group consisting of helium, neon, argon, krypton, xenon, radon, and hydrogen.

The multi-element catalyst is characterized in that the nanoparticles including the noble metal and the first transition metal are supported on the carbon support, and the nanoparticles have a core-shell structure in which a core of the intermetallic alloy phase including the first transition metal and the noble metal is surrounded by a shell including the noble metal.

The core may include a second transition metal, or may further include the second transition metal, . . . , and an n-th transition metal.

The multi-element catalyst may contain the noble metal in an amount of 63 to 80 atomic %, specifically 64 to 72 atomic %, more specifically 65 to 68 atomic %, and most specifically 65.8 to 67 atomic %, based on 100 atomic % of the total nanoparticles.

When the nanoparticles include iron (Fe) and cobalt (Co), the iron (Fe) may be included in an amount of 8 to 20 atomic %, specifically 10 to 18 atomic %, more specifically 11 to 15 atomic %, and the cobalt (Co) may be included in an amount of 15 to 28 atomic %, specifically 17 to 25 atomic %, more specifically 18 to 23 atomic %, and most specifically 20 to 22 atomic %, based on 100 atomic % of the total nanoparticles.

The size of the nanoparticles may be 1 to 15 nm, specifically 3 to 12 nm, more specifically 5 to 10 nm, and most specifically 6 to 7 nm.

Although not explicitly described in the examples and comparative examples below, electrodes including multi-element catalysts were prepared by the method for preparing a multi-element catalyst according to the present disclosure under different conditions. Then, they were applied to fuel cells, and durability and long-term stability tests were conducted using conventional methods. After 1,500 charge/discharge cycles, charge/discharge capacity was evaluated and the shape of the catalyst in the electrode was investigated.

As a result, it was confirmed that the intermetallic crystal structure of the multi-element catalyst was maintained and the nanoparticles remained uniformly dispersed without aggregation when all of the following conditions below were satisfied, after the 1,500 charge/discharge cycles.
(1) The distance between crystal planes of the carbon support is 3.3 to 3.5 nm as determined by transmission electron microscopy (TEM) analysis, and the half-width of the first peak appearing at 20° to 30° is smaller than 5° as determined by X-ray diffraction (XRD) analysis.
(2) The first transition metal precursor is Fe(CO)₅.
(3) The mixture further contains Co₂(CO)₈.
(4) The surface stabilizer is benzoic acid.
(5) The reducing agent is ethylene glycol (EG).
(6) The concentration of the carbon support in the solvent is 2 to 5 g/L.
(7) The weight ratio of the carbon support and the sum of the transition metal precursor and the noble metal precursor is 30:100 to 130.
(8) The reaction is performed at 115 to 125° C. for 8 to 20 minutes.
(9) The first heat treatment is performed at 155 to 165° C. for 0.8 to 1.2 hours.
(10) The acid solution contains perchloric acid (HClO₄) at a concentration of 0.08 to 0.2 M.
(11) The step (iii) is performed for 0.9 to 1.5 hours.
(12) The second heat treatment is performed in an inert gas atmosphere at 680 to 730° C. for 2 to 4 hours.
(13) The nanoparticles include platinum (Pt), iron (Fe), and cobalt (Co), and the amount of the platinum (Pt) is 65.8 to 67 atomic %, the amount of the iron (Fe) is 11 to 15 atomic %, and the amount of the cobalt (Co) is 20 to 22 atomic %, per 100 atomic % of the total nanoparticles.

However, when any of the above 13 conditions was not satisfied, the intermetallic crystal structure changed to some extent from the initial state after the 1,500 charge/discharge cycles, and the nanoparticles were distributed nonuniformly due to aggregation as compared to the initial state.

The present disclosure can be modified variously and can have various exemplary embodiments. Hereinafter, specific exemplary embodiments will be described in detail referring to the attached drawings. However, it is not intended to limit the present disclosure to the specific exemplary embodiments and they should be understood to encompass all modifications, equivalents or substitutes included within the scope of the present disclosure.

### Example 1. Multi-Element Catalyst Wherein Platinum-Based Ternary Intermetallic Nanoparticles (PtₓCo_{y}Fe_{z}) are Supported on Highly Crystalline Carbon

A platinum precursor (Pt(acac)₂, 30 mg), an iron precursor (Fe(CO)₅, 20 μL, 29 mg), a cobalt precursor (Co₂(CO)₈, 51 mg), 10 mL of DMF (N,N-dimethylformamide), 2 mL of EG (ethylene glycol), 96 mg of benzoic acid, and 30 mg of highly crystalline carbon powder were added to a 50-mL vial and stirred at 120° C. for 10 minutes in an Ar atmosphere to allow the precursors to be dissociated and mixed sufficiently. Next, after heating to 160° C., first heat treatment was performed for 1 hour and then the mixture was cooled to room temperature. Next, after adding a mixed solution of acetone and ethanol to the mixture, the synthesized highly crystalline carbon-supported alloy catalyst powder was extracted through centrifugation.

Next, the extracted catalyst powder was acid-treated in a 0.1 M HClO₄ solution for 1 hour. After drying, a multi-element catalyst was obtained by performing second heat treatment in an Ar atmosphere at 700° C. for 4 hours.

### Example 2. Multi-Element Catalyst Wherein Platinum-Based Binary Intermetallic Nanoparticles (PtₓFe_{y}) are Supported on Highly Crystalline Carbon

A platinum precursor (Pt(acac)₂, 30 mg), an iron precursor (Fe(CO)₅, 20 μL, 29 mg), 10 mL of DMF (N,N-dimethylformamide), 2 mL of EG (ethylene glycol), 96 mg of benzoic acid, and 30 mg of highly crystalline carbon powder were added to a 50-mL vial and stirred at 120° C. for 10 minutes in an Ar atmosphere to allow the precursors to be dissociated and mixed sufficiently. Next, after heating to 160° C., first heat treatment was performed for 1 hour and then the mixture was cooled to room temperature. Next, after adding a mixed solution of acetone and ethanol to the mixture, the synthesized highly crystalline carbon-supported alloy catalyst powder was extracted through centrifugation.

Next, the extracted catalyst powder was acid-treated in a 0.1 M HClO₄ solution for 1 hour. After drying, a binary catalyst was obtained by performing second heat treatment in an Ar atmosphere at 700° C. for 4 hours.

### Comparative Example 1

After synthesizing nanoparticles in the same manner as in Example 1, the extracted catalyst powder was subjected to second heat treatment without surface control and modification through acid treatment. Details are as follows.

A platinum precursor (Pt(acac)₂, 30 mg), an iron precursor (Fe(CO)₅, 20 μL, 29 mg), a cobalt precursor (Co₂(CO)₈, 51 mg), 10 mL of DMF (N,N-dimethylformamide), 2 mL of EG (ethylene glycol), 96 mg of benzoic acid, and 30 mg of highly crystalline carbon powder were added to a 50-mL vial and stirred at 120° C. for 10 minutes in an Ar atmosphere to allow the precursors to be dissociated and mixed sufficiently. Next, after heating to 160° C., first heat treatment was performed for 1 hour and then the mixture was cooled to room temperature. Next, after adding a mixed solution of acetone and ethanol to the mixture, the synthesized highly crystalline carbon-supported alloy catalyst powder was extracted through centrifugation.

After drying, a multi-element catalyst was obtained by performing second heat treatment in an Ar atmosphere at 700° C. for 4 hours.

### Test Example 1. Transmission Electron Microscopy (TEM) Analysis

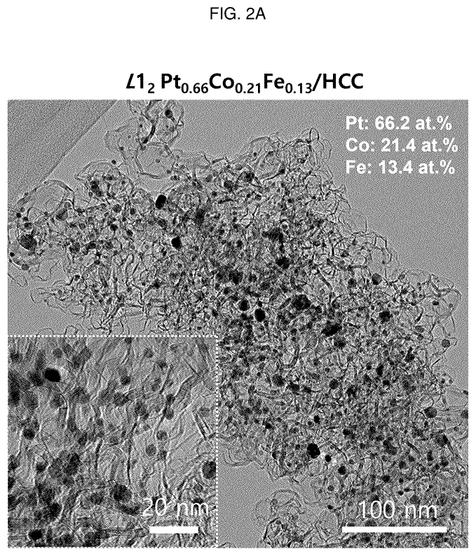

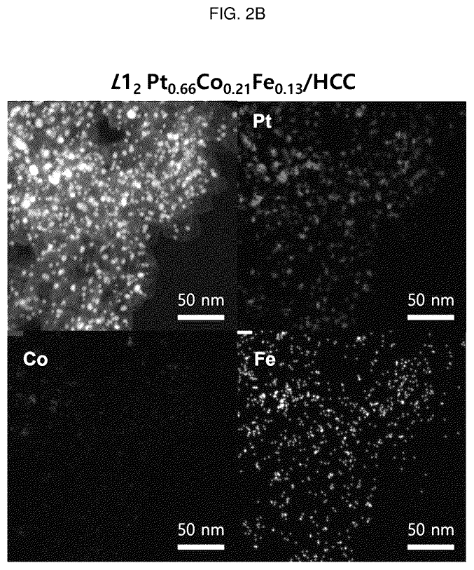

The structures of the multi-element catalysts prepared in Examples 1 and 2 and the catalyst prepared in Comparative Example 1 were analyzed using a transmission electron microscope (TEM). The result is shown in FIGS. 2 to 5.

FIGS. 2A-2B show (2A) a transmission electron microscope (TEM) image, and (2B) an energy-dispersive X-ray spectroscopy (EDS) elemental mapping image of the multi-element catalyst prepared in Example 1 of the present disclosure.

Referring to FIGS. 2A-2B, it can be seen that the platinum-based alloy nanocatalyst of the present disclosure is composed of platinum, cobalt, and iron, and is in the form of nanoparticles having a size of 6 to 7 nm and dispersed well in the highly crystalline carbon.

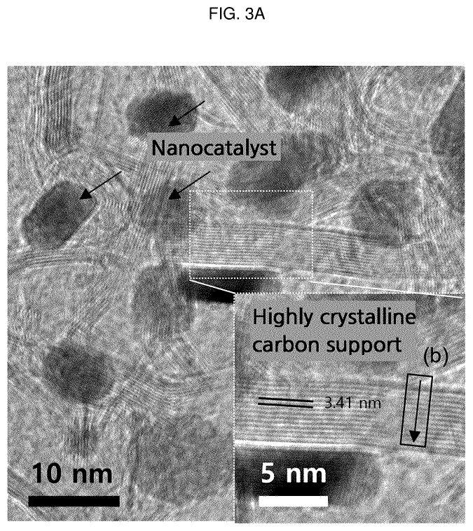

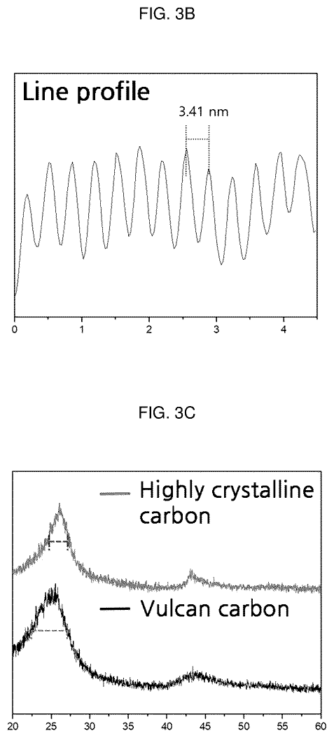

FIGS. 3A-3C show (3A) a high-resolution transmission electron microscope (HRTEM) image, (3B) a line profile, and (3C) an X-ray diffraction (XRD) analysis result for the highly crystalline carbon used in the multi-element catalyst prepared in Example 1 of the present disclosure.

Referring to FIGS. 3A-3C, it can be seen that the platinum-based alloy nanocatalyst of the present disclosure is dispersed well and supported on the highly crystalline carbon. In addition, it can be seen that the multi-element catalyst prepared in Example 1 exhibits the distance between (002) crystal planes of about 3.41 nm (FIGS. 3A and 3B). In addition, the PXRD measurement result showed that the half-widths of specific peaks (20 to 30° and 42° to 47°) were narrower than those of the commonly used Vulcan carbon support. In particular, the half-width of the first peak appearing at 20 to 30° was 2θ<3°, indicating that the crystallinity of the carbon support used in Example 1 was higher than that of the commonly used Vulcan carbon support (2θ>4°) (FIG. 3C).

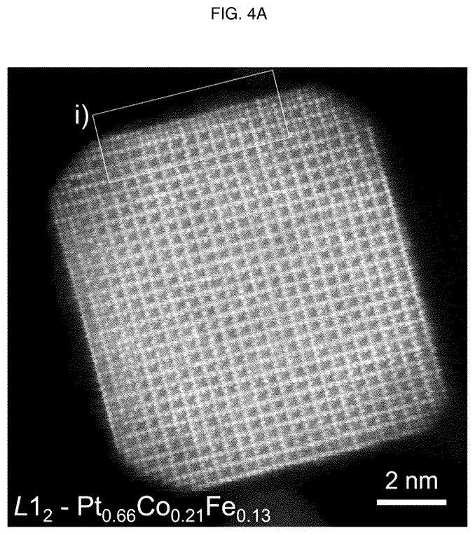

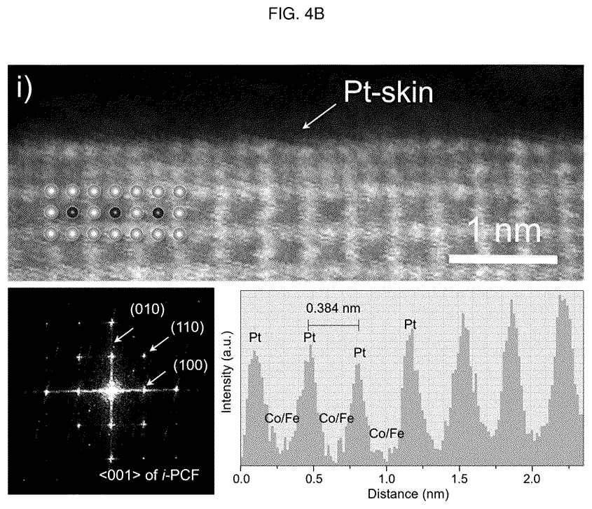

FIG. 4 shows the high-resolution scanning transmission electron microscope (HRSTEM) image, and the FFT (fast Fourier transfer) analysis and line profile analysis results of the multi-element catalyst prepared in Example 1 of the present disclosure.

Referring to FIGS. 4A and 4B, it can be seen that the multi-element catalyst prepared in Example 1 of the present disclosure is crystallized in an L₁₂ superlattice structure in which platinum and transition metal atoms are highly aligned, and a platinum layer is formed on the surface.

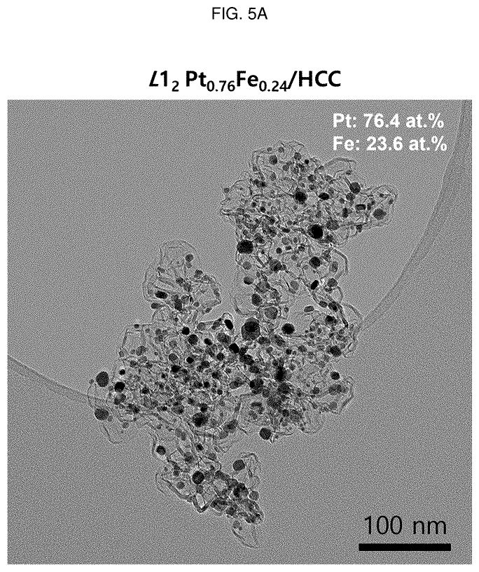

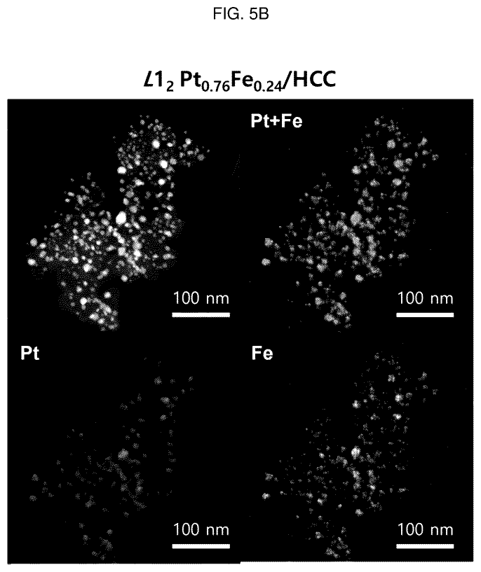

FIGS. 5A and 5B show the transmission electron microscopy (TEM) image and energy-dispersive X-ray spectroscopy (EDS) elemental mapping image of the multi-element catalyst prepared in Example 2.

Referring to FIGS. 5A and 5B, it can be seen that the multi-element catalyst of the present disclosure includes binary intermetallic nanoparticles.

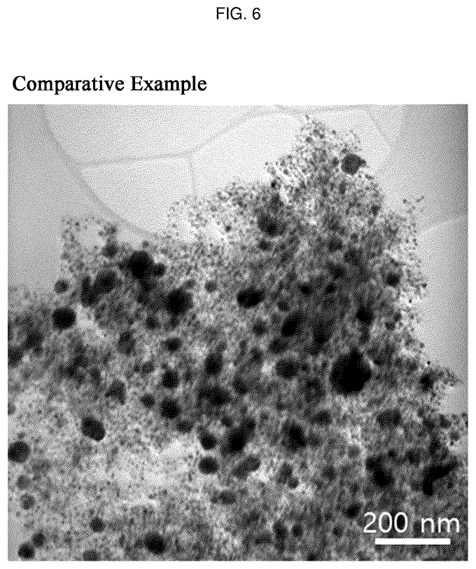

FIG. 6 shows the transmission electron microscope (TEM) image of the catalyst prepared in Comparative Example 1 of the present disclosure.

Referring to FIG. 6, it can be seen that when a catalyst is synthesized without binding of highly crystalline carbon without surface treatment through acid treatment, particle aggregation occurs during the heat treatment process.

### Test Example 2. X-Ray Diffraction (XRD) Analysis

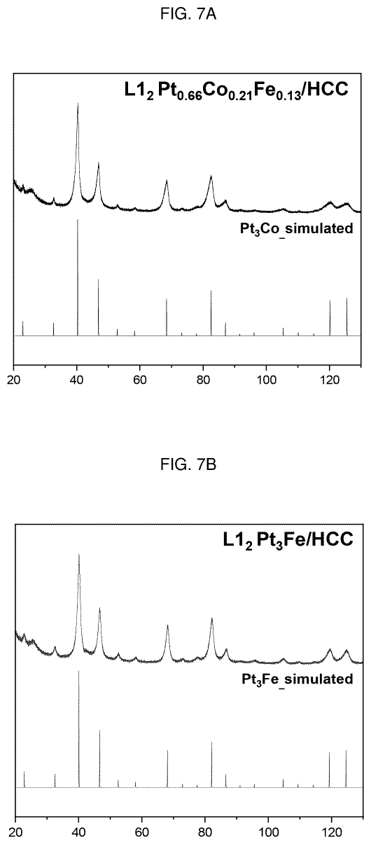

The X-ray diffraction analysis (XRD) of the multi-element catalysts prepared in Examples 1 and 2 is shown in FIGS. 7A and 7B.

FIGS. 7A and 7B show X-ray diffraction analysis (XRD) result for the multi-element catalysts prepared in Example 1 (Pt_{0.66}Co_{0.21}Fe_{0.13}/HCC) and Example 2 (Pt₃Fe/HCC) of the present disclosure.

Referring to FIGS. 7A and 7B, it can be seen that the multi-element catalysts prepared in Examples 1 (multi-element) and 2 (binary) exhibit a first main peak and a second main peak, which represent an alloy phase, at 2θ of 40° to 45° and 45° to 50°, respectively, as measured by PXRD, and in addition, exhibit a first effective peak, a second effective peak, a third effective peak, and a fourth effective peak, which are characteristic of an intermetallic phase, at 2θ of 20° to 25°, 30° to 35°, 50° to 55°, and 55° to 60°, respectively. Through this, it can be confirmed that the alloy nanocatalysts prepared in Examples 1 and 2 have an L₁₂ superlattice crystal structure, which is a specific crystal structure observed in platinum-based Pt₃M superlattice nanoparticles. In addition, it can be confirmed that the intensity ratios of (second effective peak)/(first main peak) of Examples 1 and 2 are 0.035 and 0.049, respectively, indicating sufficient (20% or higher) intermetallic phases as 45% and 63%, respectively.

Since TEM is a very localized analysis method, whereas XRD analysis shows analysis results for the entire sample, it can be seen from FIGS. 7A and 7B that most of the nanoparticles existing on carbon exist in an intermetallic crystal structure, and it can be confirmed that the multi-component alloy nanoparticles according to Examples 1 and 2 have nanoparticles supported uniformly on the highly crystalline carbon.

What is claimed is:

1. A multi-element catalyst comprising (A) a carbon support and (B) nanoparticles, wherein
the nanoparticles are supported on the carbon support and comprise a noble metal and a first transition metal, and
the nanoparticles have a core-shell structure in which a core of an intermetallic alloy phase comprising a part of the noble metal and the first transition metal is surrounded by a shell comprising another part of the noble metal or the remainder of the noble metal.

2. The multi-element catalyst according to claim 1, wherein the multi-element catalyst exhibits, as a result of X-ray diffraction (PXRD) analysis,
a first main peak and a second main peak at 2θ of 40° to 45° and 45° to 50°, respectively,
a first effective peak, a second effective peak, a third effective peak, and a fourth effective peak at 2θ of 20° to 25°, 30° to 35°, 50° to 55°, and 55° to 60°, respectively, and
an intensity ratio of the second effective peak to the first main peak ((second effective peak)/(first main peak)) of 0.0156 to 0.078.

3. The multi-element catalyst according to claim 1, wherein the nanoparticles comprise an L₁₂ superlattice structure in a transmission electron microscope (TEM) image.

4. The multi-element catalyst according to claim 1, wherein the carbon support exhibits the distance between (002) crystal planes of 2 to 5 nm as a result of transmission electron microscopy (TEM) analysis, and exhibits the half-width of the first peak appearing at 20° to 30° of smaller than 3° as a result of X-ray diffraction (XRD) analysis.

5. The multi-element catalyst according to claim 1, wherein the noble metal is one or more selected from a group consisting of platinum (Pt), gold (Au), silver (Ag), palladium (Pd), iridium (Ir), osmium (Os), rhodium (Rh), and ruthenium (Ru).

6. The multi-element catalyst according to claim 1, wherein in the amount of the noble metal is 63 to 80 atomic % per 100 atomic % of the total nanoparticles.

7. The multi-element catalyst according to claim 1, wherein the first transition metal is one or more selected from a group consisting of iron (Fe), cobalt (Co), chromium (Cr), manganese (Mn), nickel (Ni), and vanadium (V).

8. The multi-element catalyst according to claim 1, wherein the nanoparticles further comprise a second transition metal, and the core further comprises the second transition metal.

9. The multi-element catalyst according to claim 1, wherein
the intermetallic alloy nanoparticles comprise iron (Fe) and cobalt (Co),
the iron (Fe) is comprised in an amount of 8 to 20 atomic %, and
the cobalt (Co) is comprised in an amount of 15 to 28 atomic %, per 100 atomic % of the total nanoparticles.

10. The multi-element catalyst according to claim 1, wherein the multi-element catalyst exhibits catalytic activity for one or more reaction selected from a group consisting of an oxygen reduction reaction, a hydrogen evolution reaction, an ammonia oxidation reaction, a hydrogen oxidation reaction, a water electrolysis-based catalytic reaction, and a fuel cell-based catalytic reaction.

11. An electrode for a fuel cell, comprising the multi-element catalyst according claim 1.

12. A fuel cell comprising the electrode for a fuel cell according to claim 11.

13. A device comprising the fuel cell according to claim 12, wherein the device is one or more selected from a power generation device, a transportation device, a communication device, an electronic device, a military device, and a space device.
